(19) United States
(12) Patent Application Publication
(10) Pub. No.: US 2005/0253059 A1
(43) Pub. Date: Nov. 17, 2005

(54) Tandem-in-time and-in-space mass spectrometer and associated method for tandem mass spectrometry

(76) Inventors: Douglas E. Goeringer, Oak Ridge, TN (US); Scott Alexander McLuckey, West Lafayette, IN (US)

Correspondence Address: UT-Battelle, LLC;Office of Intellectual Property, One Bethal Valley Road, 4500N, MS-6258, Oak Ridge, TN, 37831, US

(21) Appl. No.: 10/845,468

(22) Filed: May 13, 2004

(51) Int. Cl. H01J 49/00

(52) U.S. Cl. 250/281; 250/282

(57) ABSTRACT

Applicant's present invention comprises an apparatus having a tandem configuration of a three-dimensional or linear RF multipole ion trap, a linear RF multipole device and a time-of-flight mass spectrometer, and the associated method of operation generating an associated product ion mass spectrum and a mass spectrum of residual parent ions wherein the associated product ion mass spectrum is combined with the mass spectrum of the residual parent ions to generate a three-dimensional mass spectrum of parent and associated product ions from a single, stored population of heterogeneous ions.

The United States government has rights in this invention pursuant to contract no. DE-AC05-00OR22725 between the United States Department of Energy and UT-Battelle, LLC.

### FIELD OF THE INVENTION

The present invention relates to instrumentation and associated methods for molecular characterization by means of gas-phase ion properties, and more particularly to instrumentation comprising a tandem configuration of a three-dimensional or linear RF multipole ion trap, a linear RF multipole device and a time-of-flight mass spectrometer, and the associated method of operation whereby the combination generates a complete three-dimensional mass spectrum of parent and associated product ions from a single, heterogeneous collection of ions.

### BACKGROUND OF THE INVENTION

Because of the complexity of the mass spectra obtained from ionization of a mixture of compounds, some type of preliminary separation is typically necessary. Mass spectrometry can then be performed on separated collections of (parent) molecular ions, rather than simultaneously on the bulk of the generated ions. In tandem mass spectrometry or MS/MS, this separation is effected via an intermediate stage of parent ion isolation via mass spectrometry following ionization. Another ion separation technique that has been used to separate the bulk of the ions in time prior to mass spectrometry analysis is ion mobility spectrometry (IMS). In IMS, ions having larger collision cross-sections move more slowly through an electric field imposed on a buffer gas-filled drift tube than those having smaller collision cross-sections. In either situation, product ion mass spectra, free from signals due to unrelated parent ions, are then generated by dissociation of the discrete parent ions. Because the associated product ions are generally characteristic of the parent ion, their mass spectrum furnishes information for identification of individual components from the complex mixture. Combining the mass spectrum of parent ions from the compound mixture with the product ion mass spectra associated with each type of parent ion enables a three-dimensional mass spectrum to be generated.

Conventional linear RF multipole devices use parallel-spaced hyperbolic or round rods, operating with radio frequency (RF) sinusoidal, and in some instances DC voltages applied to one or more rods to achieve ion manipulation and analysis. The combination of RF and DC voltages can be adjusted to establish stable trajectories through the devices for ions of only a specific mass-to-charge ratio (m/z) value (quadrupole mass filter), or only RF voltages can be applied to transmit ions over a broad m/z range (multipole ion guide). Furthermore, in the latter case, parent ions can be confined while colliding with background gas to achieve dissociation (multipole collision cell). The RF and DC voltages of quadrupoles can also be scanned synchronously to produce a mass spectrum of ions entering the device. Triple quadrupole (QqQ) instruments are widely used for tandem mass spectrometry, such systems having three linear quadrupoles arranged in an end-to-end configuration. Because the QqQ is normally operated so that parent ion selection in Q1, parent ion dissociation in q2, and product ion mass analysis in Q3 occur sequentially in space as ions traverse the instrument, the MS/MS process is known as tandem-in-space.

A three dimensional quadrupole ion trap (QIT) typically consists of one annular ring electrode, which has a RF sinusoidal voltage applied, located between two endcap electrodes, which are grounded during most of the operational cycle time. Ions over a wide range of mass-to-charge ratio values can be trapped and confined inside the cavity formed by the electrodes, oscillating in stable trajectories at mass-to-charge ratio dependent frequencies. By application of suitable auxiliary AC and DC potentials to the electrodes, the stored ions can be mass analyzed by sequentially scanning them out of the device according to mass-to-charge ratio value, or ejected selectively at discrete mass-to-charge values. MS/MS also can be achieved by kinetic excitation of stored parent ions at the resonant frequency to effect mass-to-charge ratio selective dissociation via collisions with buffer gas, followed by mass analysis of the trapped product ions. Because selective parent ion dissociation and subsequent product ion mass analysis can be performed within the same volume, MS/MS in a quadrupole ion trap is often referred to as tandem-in-time.

One limitation of triple quadrupole instruments and quadrupole ion trap instruments as used for MS/MS is that acquisition of a product ion mass spectrum can be time consuming because the mass analyzer (Q3 or the QIT itself) must scan through many mass-to-charge ratio values to record a complete spectrum. In addition, in the triple quadruple instrument, all other product ions outside of the transmission window are lost. Furthermore, when a triple quadrupole instrument or quadrupole ion trap instrument is performing an MS/MS analysis on parent ions having a specific mass-to-charge ratio value, additional parent ions at different mass-to-charge ratio values cannot be introduced. Thus, during the product ion mass analysis time, ions produced by the ion source may be wasted, resulting in a very low duty cycle and poor overall sensitivity for the system.

To overcome such limitations, recent instrument development has focused on tandem mass spectrometry with hybrid multipole/time-of-flight instruments such as the QqTOF and the IMSQqTOF. QqTOF mass spectrometers (Morris et. al., 1996; Shevchenko et. al., 1997) are somewhat analogous to QqQ instruments in that parent ions are selected by mass-to-charge value in a quadrupole mass filter and then dissociated in a multipole collision cell. However, the resultant product ions are mass analyzed in a time-of-flight mass spectrometer (TOF-MS). The advantage of the TOF-MS is that it can record 10,000 or more complete mass spectra in one second without scanning. Thus, product ion mass spectra can be acquired more quickly, and the duty cycle is greatly improved. In addition, to further enhance the duty cycle efficiency for a selected parent ion, the multipole collision cell has been configured as a linear ion trap enabling dissociation and product ion trapping to be carried out together. Pulses of the trapped ions are released periodically into the TOF to determine their mass spectrum (Chemushevich et. al., U.S. Pat. No. 6,507,019, incorporated herein by reference). However, as with the triple quadrupole ion instruments, additional parent ions at different mass-to-charge ratio values cannot be introduced during MS/MS analysis.

Quadrupole ion traps have also been used in such hybrid instruments (Douglas, U.S. Pat. No. 5,179,278). The combination involved a two-dimensional multipole ion guide with a quadrupole ion trap (QIT) where all ions trapped in the multipole ion guide were emptied into the QIT prior to each time-of-flight pulse. Dresch et. al. (U.S. Pat. No. 5,689,111) describe an instrument which couples a linear two-dimensional multipole ion guide, switched to operate as an ion trap, with a time-of-flight mass analyzer. However, this is not a tandem instrument in that there is only a single multipole ion guide, thereby precluding the ability to provide upstream mass-resolved parent ion selection. In another ion trap/time-of-flight instrument (QITTOF), parent ion selection by mass-to-charge ratio and dissociation initially occurred in the quadrupole ion trap, and the product ions were then pulsed into the time-of-flight mass spectrometer (TOF-MS) for mass analysis (Qian et. al., 1996). The disadvantage of TOF-MS for rapid acquisition of mass spectra is somewhat negated however, because the quadrupole ion trap is only capable of selecting and dissociating parent ions at less than 50 times per second.

In the IMSQqTOF instrument, the ion outlet of the IMS is coupled to a quadrupole mass filter, the output of which is coupled to a collision cell, which in turn has its ion outlet coupled to the TOF-MS (Clemmer et. al. U.S. Pat. Nos. 5,905,258; 6,323,482). The IMSQqTOF, unlike most MS/MS instruments however, is unable to arbitrarily control parent ion selection and spacing in time.

### OBJECTS OF THE INVENTION

Accordingly, it is an object of the present invention to provide a tandem-in-time and -in-space mass spectrometer having improved speed in the generation and acquisition of a complete three-dimensional mass spectrum of parent and associated product ions from a single, heterogeneous collection of ions.

It is another object of the present invention to provide a tandem-in-time and -in-space mass spectrometer having an enhanced duty cycle efficiency for generation and acquisition of a complete three-dimensional mass spectrum of parent and associated product ions from a single, heterogeneous collection of ions.

It is yet another object of the present invention to provide a more flexible approach for tandem mass spectrometry.

These and other objects, features and advantages of the present invention will become apparent after a review of the following detailed description of the disclosed embodiments and the appended claims.

### SUMMARY OF THE INVENTION

In accordance with one aspect of the present invention, the foregoing and other objects are achieved by an apparatus having a tandem configuration for generating a three-dimensional mass spectrum of parent and associated product ions from a single, stored population of heterogeneous ions. The apparatus comprises a means for generating a gaseous bulk of heterogeneous ions from a sample source and a RF multipole ion trap having an ion inlet coupled to the means for generating a gaseous bulk of heterogeneous ions from a sample source and further having an ion outlet coupled in a tandem configuration to a linear RF multipole collision cell wherein the bulk of heterogeneous ions enters the RF multipole ion trap through the ion inlet. The RF multipole ion trap is operable to collect the bulk of heterogeneous ions and store for a period of time to accumulate a suitable number of ions after which time the stored collection of heterogeneous ions is sorted into ion packets of parent ions according to mass-to-charge ratio and the ion packets are ejected sequentially through the ion outlet, wherein the suitable number of ions being a number of ions sufficient enough to generate a measurable product or parent ion signal. The apparatus further comprises a linear RF multipole collision cell having an ion inlet coupled in a tandem configuration to the ion outlet of the RF multipole ion trap and having an ion outlet coupled in a tandem configuration to a time-of-flight mass spectrometer wherein the ion packets sequentially enter the RF multipole collision cell through the ion inlet. The RF multipole collision cell is configured and operable to allow a collision gas to accumulate at pressure sufficient to efficiently dissociate the parent ions into associated product ions during transit of the ion packets whereby the ion packets comprise residual parent ions and the associated product ions. The apparatus further comprises a time-of-flight mass spectrometer having an ion inlet coupled in a tandem configuration to the ion outlet of the RF multipole collision cell wherein the ion packets sequentially enter the time-of-flight mass spectrometer ion inlet from the RF multipole collision cell ion outlet, the time-of-flight mass spectrometer further having an acceleration region wherein pulsed operation of the time-of-flight mass spectrometer is initiated upon the ion packets sequentially entering the acceleration region whereby an associated product ion mass spectrum and a mass spectrum of parent ions are obtained corresponding to each of the ion packets whereby the product ion mass spectrum associated with each type of parent ion and the mass spectrum of parent ions are combined to generate a three-dimensional mass spectrum of parent and associated product ions.

In accordance with another aspect of the present invention, other objects are achieved by the apparatus described above and further comprising a second linear RF multipole ion trap having an ion inlet coupled to the means for generating the gaseous bulk of heterogeneous ions and further having an ion outlet coupled in a tandem configuration to the RF multipole ion trap of the above apparatus. The bulk of heterogeneous ions enters the second linear RF multipole ion trap through the ion inlet and the bulk of heterogeneous ions exit the second RF multipole ion trap through the ion outlet. The second RF multipole ion trap is operable to collect the bulk of heterogeneous ions for a period of time to accumulate a suitable number of ions whereby the bulk of heterogeneous ions is ejected from the second RF multipole ion trap in a single ion packet. A suitable number of ions being a number of ions sufficient enough to generate a measurable product or parent ion signal. The second RF multipole ion trap provides additional ion storage therein enabling collection of ions for subsequent analysis while MS/MS of the bulk of heterogeneous ions in the RF multipole ion trap is being performed thereby enhancing the duty cycle and efficiency of the apparatus.

In accordance with yet another aspect of the present invention, other objects are achieved by a method for generating a three-dimensional mass spectrum of parent and associated product ions from a single, stored population of heterogeneous ions using the apparatus described above wherein the method comprises the steps of a) providing a gaseous bulk of heterogeneous ions from a sample source; b) admitting the bulk of heterogeneous ions into an RF multipole; c) collecting the bulk of heterogeneous ions in the RF multipole ion trap for a time period to accumulate a suitable number of ions wherein the bulk of heterogeneous ions are sorted into ion packets according to mass-to-charge ratio. A suitable number of ions being a number of ions sufficient enough to generate a measurable product or parent ion signal. The method further comprises the steps of d) sequentially ejecting the ion packets from the RF multipole ion trap into a linear RF multipole collision cell wherein the parent ions are dissociated into associated product ions via energetic ion-neutral collisions during transit of the ion packets and wherein after dissociation, the ion packets comprise the product ions and residual parent ions; e) sequentially delivering pulses of the ion packets from the linear RF multipole collision cell to an acceleration region of a time-of-flight mass spectrometer wherein pulsed operation of the time-of-flight mass spectrometer is initiated upon the ion packets sequentially entering the acceleration region; and f) generating an associated product ion mass spectrum and a mass spectrum of the residual parent ions corresponding to each of the ion packets wherein the associated product ion mass spectrum is combined with the mass spectrum of the residual parent ions thereby generating a three-dimensional mass spectrum of parent and associated product ions from a single, stored population of heterogeneous ions.

### BRIEF DESCRIPTION OF THE DRAWINGS

In the drawings:

FIG. 1 shows an embodiment of Applicant's tandem configuration.

FIG. 2 shows a second embodiment of Applicant's tandem configuration.

For a better understanding of the present invention, together with other and further objects, advantages and capabilities thereof, reference is made to the following disclosure and appended claims in connection with the above-described drawings.

### DETAILED DESCRIPTION OF THE INVENTION

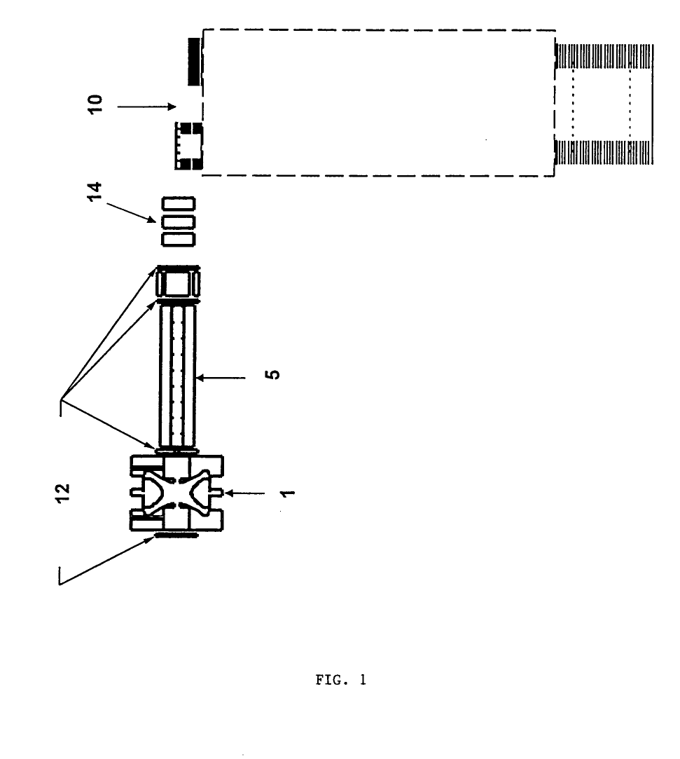

Applicant's present invention comprises a tandem configuration of a three-dimensional or linear RF quadrupole ion trap (QIT) or other RF multipole ion trap, a linear RF multipole collision cell (mp), and a time-of-flight mass spectrometer (TOF) so that the ion outlet of the ion trap is coupled to the ion inlet of the linear multipole collision cell, and the ion outlet of the linear multipole collision cell is coupled to the ion acceleration region of the time-of-flight mass spectrometer. A three-dimensional or linear RF quadrupole ion trap may be used in this configuration. A linear RF hexapole (h) or octopole (o) may also be used in this configuration as well. The present invention further comprises the associated method of operation whereby the combination generates a complete three-dimensional mass spectrum of parent and associated product ions from a single, heterogeneous population of ions. FIG. 1 shows that the RF quadrupole ion trap (QIT) 1 of the present invention is configured to accumulate and eject ions in a selective manner. The outlet of the ion trap 1 is coupled to the linear RF multipole collision cell (mp) 5 that is configured to allow a collision gas to accumulate at pressure sufficient to efficiently dissociate ions during their transit through the device. The outlet of the linear RF multipole collision cell 5 is coupled to a time-of-flight mass spectrometer (TOF) 10 in a tandem configuration (QITmpTOF). Ion optics for ion beam shaping to assist transport of ions from one component to another or to adjust ion kinetic energy may also be used. These ion optics may include aperture/gating lenses 12 and Einzel/acceleration/deceleration lenses 14.

The method of Applicant's invention comprises the first step of admitting ions into the multipole ion trap where they accumulate temporarily. A heterogeneous ion population emanating from a suitable ion source is collected in the multipole ion trap. Then, after a suitable number of ions are collected over a suitable time period, packets of the stored (parent) ions, sorted according to mass-to-charge ratio, are sequentially ejected into the linear multipole collision cell where dissociation of the parent ions into product ions occurs via energetic ion-neutral collisions during transit. A suitable number of ions being defined as enough ions collected and stored to generate a measurable product (or parent) ion signal from the time-of-flight mass spectrometer. The resultant pulses of ion packets containing any remaining intact parent ions and their associated product ions are delivered to the ion outlet of the linear RF multipole. The pulses of ion packets containing the residual parent ions and their associated product ions then enter the inlet of the time-of-flight mass spectrometer (TOF). As each of the ion packets sequentially enters the acceleration region of TOF, pulsed operation of TOF is initiated and the associated product ion mass spectrum is obtained. Combining the mass spectrum of parent ions from the compound mixture with the product mass spectra associated with each type of parent ion enables a three-dimensional spectrum to be generated. During operation, the parent ion scan rate or the ejection rate and sequence from the multipole ion trap can be adjusted so that the period between packets of parent ions coincides with their transit times through TOF.

In another embodiment, the linear RF multipole collision cell is configured as a linear multipole ion trap enabling dissociation of parent ion packets and trapping of the associated product ions to be carried out together. Pulses of the trapped product ions and any residual parent ions are released periodically into the TOF to determine their mass spectrum.

Another embodiment enables optimization of parent ion dissociation by configuring the instrument to permit adjustment of the kinetic energy of parent ions entering the linear RF multipole collision cell. The kinetic energy adjustment may be effected by using acceleration/deceleration ion optics or by varying the offset potential of the multipole collision cell.

Furthermore, Applicant's present invention enables a mass spectrum of the heterogeneous ion population stored in the multipole ion trap to be obtained using the time-of-flight mass spectrometer (TOF). In this embodiment, the entire population of heterogeneous ions is ejected from the multipole ion trap into the linear RF multipole collision cell as a single packet. However, in this case, the kinetic energy of the parent ion packet is adjusted via the method indicated in the previous embodiment, so that ion-neutral collisions are not sufficiently energetic for dissociation to occur during transit through the RF multipole collision cell. The resultant pulse of intact parent ions is delivered to the ion outlet of the linear RF multipole collision cell and then enters the inlet of the time-of-flight mass spectrometer. When the ion packet enters the acceleration region of TOF, pulsed operation of TOF is initiated and the mass spectrum of the heterogeneous ion population is obtained.

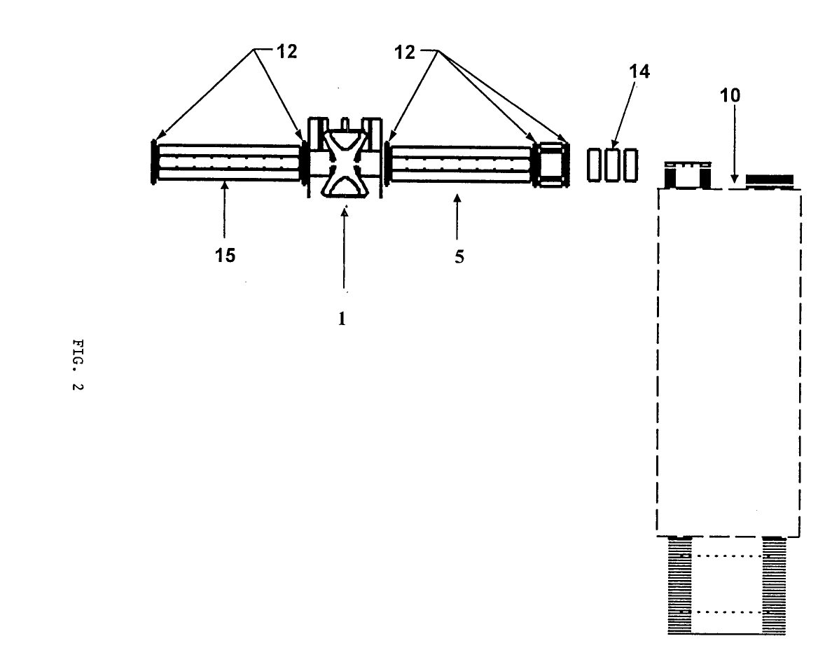

Another embodiment of Applicant's configuration, shown in FIG. 2, incorporates a second linear RF multipole ion trap 15 so that its ion outlet is coupled in tandem configuration to the ion inlet of the first RF multipole ion trap 1. The second multipole ion trap is configured to accumulate a heterogeneous ion population emanating from a suitable source. After a suitable number of ions (previously defined) are collected and stored in the second multipole ion trap, the entire population of stored ions is ejected in a single packet from the second multipole ion trap 15 into the first multipole ion trap 1 for storage. Accumulation of the next population of ions in the second multipole ion trap 15 is then initiated while MS/MS of the ion population in the first multipole ion trap 1 is performed as described above.

Another embodiment of Applicant's invention is the application of supplemental AC signals to the rods of the second multipole ion trap so that ions can be selectively stored by mass/charge ratio therein while unwanted ions are removed. After a suitable number of ions (as previously defined) are selectively collected and stored in the second multipole ion trap, the entire population of stored ions is ejected in a single packet from the second multipole ion trap into the first multipole ion trap for storage. Selective accumulation of the next population of ions in the second multipole ion trap is then initiated while MS/MS of the ion population in the first multipole ion trap is performed as described above. Another option for operation of Applicant's instrument is to adjust the time between the second multipole ion trap ejection pulses to coincide with the time required to scan or eject the stored ion population out of the first multipole ion trap. Additional embodiments also include the use of a different type of linear multipole ion trap, such as a hexapole or octopole, in place of the linear quadrupole ion trap. A further embodiment includes substitution of a linear quadrupole or other linear multipole, configured as an ion trap, in place of the three-dimensional quadrupole ion trap. Another embodiment replaces the linear hexapole collision cell with another type of multipole collision cell such as a quadrupole or octopole.

Applicant's instrument is particularly well suited for rapid and sensitive identification and analysis of biomolecules via mass-to-charge ratio (m/z), composition, structure, and/or sequence information. Applicant's configuration is designed to accumulate a heterogeneous population of parent ions having different mass-to-charge ratio values from a suitable ion source, to sort (by m/z and time) and dissociate packets of parent ions (from the stored population) into associated packets of product ions. It is further designed to measure the mass spectrum of each associated product ion packet and to generate a complete three-dimensional mass spectrum of parent and associated product ions (i.e., parent ion spectrum vs. associated product ion mass spectrum vs. ion intensity). Concomitant advantages of Applicant's invention include the capability to rapidly perform MS/MS analysis sequentially on multiple packets of parent ions, each selected by mass-to-charge ratio from a stored heterogeneous ion population, without the necessity of reloading the first multipole ion trap between each packet of parent ions. The additional ion storage RF multipole located upstream from the first multipole ion trap (qQIThTOF) enables collection of ions for subsequent analysis while MS/MS of the ion population in the first multipole ion trap is being performed, thereby enhancing the overall duty cycle and efficiency of the instrument.

While there has been shown and described what are at present considered the preferred embodiments of the invention, it will be obvious to those skilled in the art that various changes and modifications can be made therein without departing from the scope of the invention defined by the appended claims.

1. An apparatus having a tandem configuration for generating a three-dimensional mass spectrum of parent and associated product ions from a single, stored population of heterogeneous ions comprising:
a) means for generating a gaseous bulk of heterogeneous ions from a sample source;
b) a RF multipole ion trap having an ion inlet coupled to said means for generating said gaseous bulk of heterogeneous ions and having an ion outlet coupled in a tandem configuration to a linear RF multipole collision cell, wherein said bulk of heterogeneous ions enters said RF multipole ion trap through said ion inlet, wherein said RF multipole ion trap operable to collect said bulk of heterogeneous ions and store for a period of time to accumulate a suitable number of ions wherein the stored collection of said heterogeneous ions is sorted into ion packets of parent ions according to mass-to-charge ratio and said ion packets are ejected sequentially through said ion outlet, said suitable number of ions being a number of ions sufficient enough to generate a measurable product or parent ion signal;
c) said linear RF multipole collision cell having an ion inlet coupled in a tandem configuration to said ion outlet of said RF multipole ion trap and having an ion outlet coupled in a tandem configuration to a time-of-flight mass spectrometer, wherein said ion packets sequentially enter said RF multipole collision cell through said ion inlet, wherein said RF multipole collision cell configured and operable to allow a collision gas to accumulate at pressure sufficient to efficiently dissociate said parent ions into associated product ions during transit of said ion packets whereby said ion packets comprise residual parent ions and said associated product ions; and
d) said time-of-flight mass spectrometer having an ion inlet coupled in a tandem configuration to said ion outlet of said RF multipole collision cell wherein said ion packets sequentially enter said time-of-flight mass spectrometer ion inlet from said RF multipole collision cell ion outlet, said time-of-flight mass spectrometer further having an acceleration region wherein pulsed operation of said time-of-flight mass spectrometer is initiated upon said ion packets sequentially entering said acceleration region whereby an associated product ion mass spectrum and a mass spectrum of said residual parent ions are obtained corresponding to each of said ion packets and whereby said associated product ion mass spectrum and said mass spectrum of residual parent ions are combined to generate a three-dimensional mass spectrum of parent and associated product ions.

2. The apparatus of claim 1 wherein said apparatus further comprises a second linear RF multipole ion trap having an ion inlet coupled to said means for generating said gaseous bulk of heterogeneous ions and having an ion outlet coupled in a tandem configuration to said RF multipole ion trap of b), wherein said bulk of heterogeneous ions enters said second linear RF multipole ion trap through said ion inlet and said bulk of heterogeneous ions exits said second RF multipole ion trap through said ion outlet, said second RF multipole ion trap operable to collect said bulk of heterogeneous ions for a period of time to accumulate a suitable number of ions whereby said bulk of heterogeneous ions is ejected from said second RF multipole ion trap in a single ion packet, said suitable number of ions being a number of ions sufficient enough to generate a measurable product or parent ion signal, said second RF multipole ion trap providing additional ion storage therein enabling collection of ions for subsequent analysis while MS/MS of said bulk of heterogeneous ions in said RF multipole ion trap is being performed thereby enhancing the duty cycle and efficiency of said apparatus.

3. The apparatus of claim 1 wherein said RF multipole ion trap is a three-dimensional RF quadrupole ion trap.

4. The apparatus of claim 1 wherein said RF multipole ion trap is a linear RF quadrupole ion trap, a linear RF hexapole ion trap or a linear RF octopole ion trap.

5. The apparatus of claim 1 wherein said linear RF multipole collision cell is a linear RF quadrupole collision cell, a linear RF hexapole collision cell or a linear RF octopole collision cell.

6. The apparatus of claim 1 wherein said linear RF multipole collision cell is configured as a linear ion trap enabling dissociation of parent ion packets while simultaneously trapping said associated product ions wherein pulses of said trapped associated product ions and residual parent ions are released periodically into said time-of-flight mass spectrometer.

7. The apparatus of claim 1 further comprising acceleration/deceleration ion optics to permit adjustment of the kinetic energy of said parent ions entering said linear RF multipole collision cell.

8. The apparatus of claim 2 wherein said second linear RF multipole ion trap is a linear RF quadrupole ion trap, a linear RF hexapole ion trap or a linear RF octopole ion trap.

9. The apparatus of claim 2 wherein said RF multipole ion trap is selected from the group consisting of a three-dimensional RF quadrupole ion trap, a linear RF quadrupole ion trap, a linear RF hexapole ion trap or a linear RF octopole ion trap.

10. The apparatus of claim 2 wherein said linear RF multipole collision cell is a linear RF quadrupole collision cell, a linear RF hexapole collision cell or a linear RF octopole collision cell.

11. A method for generating a three-dimensional mass spectrum of parent and associated product ions from a single, stored population of heterogeneous ions using the apparatus of claim 1 wherein said method comprises the steps of:
a) providing a gaseous bulk of heterogeneous ions from a sample source;
b) admitting said bulk of heterogeneous ions into an RF multipole ion trap;
c) collecting said bulk of heterogeneous ions in said RF multipole ion trap for a time period to accumulate a suitable number of ions wherein said bulk of heterogeneous ions are sorted into ion packets according to mass-to-charge ratio, said suitable number of ions being a number of ions sufficient enough to generate a measurable product or parent ion signal;
d) sequentially ejecting said ion packets from said RF multipole ion trap into a linear RF multipole collision cell wherein said parent ions are dissociated into associated product ions via energetic ion-neutral collisions during transit of said ion packets and wherein after dissociation, said ion packets comprise said product ions and residual parent ions;
e) sequentially delivering pulses of said ion packets from said linear RF multipole collision cell to an acceleration region of a time-of-flight mass spectrometer wherein pulsed operation of said time-of-flight mass spectrometer is initiated upon said ion packets sequentially entering said acceleration region; and
f) generating an associated product ion mass spectrum and a mass spectrum of said residual parent ions corresponding to each of said ion packets wherein said associated product ion mass spectrum is combined with said mass spectrum of said residual parent ions thereby generating a three-dimensional mass spectrum of parent and associated product ions from a single, stored population of heterogeneous ions.

12. The method of claim 11 further comprising the step of adjusting the parent ion scan rate or the ejection rate and sequence from said multipole ion trap so that the period between said ion packets of parent ions coincides with the transit times of said ion packets through said time-of-flight mass spectrometer.

13. The method of claim 11 further comprising the step of enabling dissociation of said ion packets of parent ions while simultaneous trapping said associated product ions within said multipole collision cell wherein pulses of said trapped product ions and residual parent ions are released periodically into said time-of-flight mass spectrometer by configuring said linear multipole collision cell of said apparatus as a linear multipole ion trap.

14. The method of claim 11 further comprising the step of optimizing said parent ion dissociation by configuring said apparatus to permit adjustment of the kinetic energy of said parent ions entering said linear RF multipole collision cell by using acceleration/deceleration ion optics.

15. The method of claim 11 further comprising the step of optimizing said parent ion dissociation by configuring said apparatus to permit adjustment of the kinetic energy of said parent ions entering said linear RF multipole collision cell by varying the offset potential of said multipole collision cell.

16. The method of claim 14 further comprising the step of obtaining a mass spectrum of said heterogeneous ion population stored in said multipole ion trap wherein said population of heterogeneous ions is ejected as a whole population from said multipole ion trap into said linear RF multipole collision cell as a single parent ion packet whereby the kinetic energy of said parent ion packet is adjusted so that said ion-neutral collisions lack sufficient energy for dissociation to occur during said transit of said parent ion packet through said multipole collision cell thereby delivering the resultant pulse of parent ions to said ion outlet of said multipole collision cell and into said inlet of said time-of-flight mass spectrometer.

17. A method for generating a three-dimensional mass spectrum of parent and associated product ions from a single, stored population of heterogeneous ions using the apparatus of claim 2 wherein said method comprises the steps of:
a) providing a gaseous bulk of heterogeneous ions from a sample source;
b) admitting said bulk of heterogeneous ions into a second RF multipole ion trap;
c) collecting said bulk of heterogeneous ions in said second RF multipole ion trap for a time period to accumulate a suitable number of ions, said suitable number of ions being a number of ions sufficient enough to generate a measurable product or parent ion signal;
d) ejecting said bulk of heterogeneous ions in a single ion packet from said second RF multipole ion trap into a RF multipole ion trap wherein said bulk of heterogeneous ions are sorted into ion packets according to mass-to-charge ratio;
e) sequentially ejecting said ion packets from said RF multipole ion trap into a linear RF multipole collision cell wherein said parent ions are dissociated into associated product ions via energetic ion-neutral collisions during transit of said ion packets and wherein after dissociation, said ion packets comprise said product ions and residual parent ions;
f) sequentially delivering pulses of said ion packets from said linear RF multipole collision cell to an acceleration region of a time-of-flight mass spectrometer wherein pulsed operation of said time-of-flight mass spectrometer is initiated upon said ion packets sequentially entering said acceleration region; and
a) generating an associated product ion mass spectrum and a mass spectrum of said residual parent ions corresponding to each of said ion packets wherein said associated product ion mass spectrum is combined with said mass spectrum of said residual parent ions thereby generating a three-dimensional mass spectrum of parent and associated product ions from a single, stored population of heterogeneous ions.

18. The method of claim 17 further comprising the step of applying supplemental AC signals to the rods of said second multipole ion trap so that ions can be selectively stored by mass-to-charge ratio therein while unwanted ions are removed from said second multipole ion trap.

19. The method of claim 17 further comprising the step of adjusting the time between the ejection pulses of said second multipole ion trap to coincide with the time required to scan or eject the stored ion population out of said multipole ion trap.
